(19) United States
(12) Patent Application Publication
(10) Pub. No.: US 2011/0242237 A1
(43) Pub. Date: Oct. 6, 2011

(54) LIQUID EJECTING HEAD, LIQUID EJECTING UNIT, AND LIQUID EJECTING APPARATUS

(75) Inventor: Haruhisa Uezawa, Shiojiri-shi (JP)

(73) Assignee: SEIKO EPSON CORPORATION, Tokyo (JP)

(21) Appl. No.: 13/077,895

(22) Filed: Mar. 31, 2011

(30) Foreign Application Priority Data
Apr. 1, 2010 (JP) 2010-084888
Dec. 22, 2010 (JP) 2010-285975

(51) Int. Cl. B41J 2/18

(52) U.S. Cl. 347/89

(57) ABSTRACT

A liquid ejecting head includes a plurality of nozzle openings, a first flow path, a supply path, a recovery path, a first filter, a second filter, and a second flow path. The nozzle openings eject a liquid, the first flow path is communicated with the plurality of nozzle openings and the liquid is circulated through the first flow path. The supply path supplies the liquid to the first flow path from the outside, and the recovery path recovers the liquid from the first flow path to the outside. The first filter is provided in the supply path and the second filter is provided in the recovery path. The second flow path connects the supply path provided in the upstream side of the first filter and the recovery path provided in downstream side of the second filter.

The entire disclosure of Japanese Patent Application No: 2010-084888, filed Apr. 1, 2010 and Japanese Patent Application No: 2010-285975, filed Dec. 22, 2010 are expressly incorporated by reference herein.

### BACKGROUND

1. Technical Field

The present invention relates to a liquid ejecting head, a liquid ejecting unit, and a liquid ejecting apparatus.

2. Related Art

As an ink jet recording apparatus which is an example of a liquid ejecting apparatus according to the related art, a circulation type ink jet recording apparatus, in which an ink tank separated from ink jet recording heads is provided, and ink is circulated between the ink tank and the ink jet recording heads, has been known (for example, refer to JP-A-2009-23289 (refer to FIG. 3 or the like)).

In the ink jet recording apparatus disclosed in JP-A-2009-23289, a single outward pipe and a single inward pipe are provided in the ink tank, and ink is supplied to each of the recording heads by branching the outward pipe and the inward pipe. With respect to each of the recording heads, the upstream side circulation path of a filter and the downstream side circulation path of the filter are formed. Since the recording head includes two circulation paths, the bubble discharge efficiency is improved and sedimentation of liquid components is suppressed.

However, in the ink jet recording heads disclosed in JP-A-2009-23289, it is difficult to introduce ink to the downstream side circulation path, so that there are problems in that the bubble discharge efficiency is low and the sedimentation of liquid component is difficult to suppress. Furthermore, with respect to the ink jet recording head as described above, there is a problem in that ink is not uniformly ejected from all the nozzles at the time of ink ejection. Meanwhile, such a problem exists in not only a liquid ejecting apparatus using ink jet recording heads but also in a liquid ejecting apparatus using liquid ejecting heads which eject liquids other than ink.

### SUMMARY

Here, an advantage of some aspects of the invention is to provide a liquid ejecting head including a circulation path which has a more uniform ejection property, a liquid ejecting unit including the corresponding liquid ejecting head, and a liquid ejecting apparatus.

According to an aspect of the invention, there is provided a liquid ejecting head including a plurality of nozzle openings that eject a liquid; a first flow path that is communicated with the plurality of nozzle openings and in which the liquid is circulated; a supply path that supplies the liquid to the first flow path from the outside; a recovery path that recovers the liquid from the first flow path to the outside; a first filter that is provided in the supply path; a second filter that is provided in the recovery path; and a second flow path that connects the supply path provided in an upstream side of the first filter and the recovery path provided in downstream side of the second filter. A recovery side flow path between the first flow path and the second flow path of the recovery path has flow path resistance which is lower than flow path resistance of the supply side flow path between the first flow path and the second flow path of the supply path. In an aspect of the invention, the recovery side flow path has flow path resistance which is lower than the flow path resistance of the supply side flow path, with the result that the amount of ink to be supplied to nozzle openings in the vicinity of the recovery side flow path increases at the time of liquid ejection, so that the amount of ink ejected from the nozzle openings can be sufficiently held. Therefore, liquid ejection property can be substantially uniformalized. Meanwhile, the supply side flow path includes the first filter provided in the supply path, and the recovery side flow path includes the second filter provided in the recovery path.

Here, it is preferable that the cross-sectional area of the recovery side flow path be larger than the cross-sectional area of the supply side flow path, and that the total area of the opening of the second filter provided in the recovery path is wider than the total area of the opening of the first filter provided in the supply path. Therefore, the flow path resistance of the recovery side flow path can be lowered. Meanwhile, the cross-sectional area is the cross-sectional area of a surface which is vertical to the direction in which the liquid of a head side recovery path or a head side supply path flows.

It is preferable that the supply side flow path have flow path resistance which is the same as the flow path resistance of a flow path including the recovery side flow path and the second flow path. Therefore, uniformity can be realized. Meanwhile, the meaning of ‘the same’ includes the meaning of ‘substantially the same’ in the aspect of the invention.

The liquid ejecting head unit according to the aspect of the invention includes a plurality of liquid ejecting heads which have been described above. If the liquid ejecting head unit having such a uniform ejection property is provided, the liquid ejecting head unit according the aspect of the invention has an excellent liquid ejection property when the liquid ejection head unit is mounted in the liquid ejecting apparatus.

The liquid ejecting apparatus according to the aspect of the invention includes the liquid ejecting head described above or the plurality of liquid ejecting heads. If the liquid ejecting head having such a uniform ejection property is provided, the liquid ejecting apparatus according to the aspect of the invention has an excellent liquid ejection property when the liquid ejection head unit is mounted in the liquid ejecting apparatus.

### BRIEF DESCRIPTION OF THE DRAWINGS

The invention will be described with reference to the accompanying drawings, wherein like numbers reference like elements.

FIG. 1 is a perspective view illustrating the schematic configuration of a liquid ejecting apparatus.

FIG. 2 is a schematic diagram illustrating the configuration of a liquid flow path.

FIG. 3 is a schematic diagram illustrating the cross section of a head.

FIG. 4 is a cross-sectional schematic diagram illustrating the flow of the ink in the head at the time of ejection.

FIG. 5 is an exploded schematic diagram illustrating the schematic configuration of the head.

FIG. 6A is a plan view and FIG. 6B is a cross-sectional view of the head.

### DESCRIPTION OF EXEMPLARY EMBODIMENTS

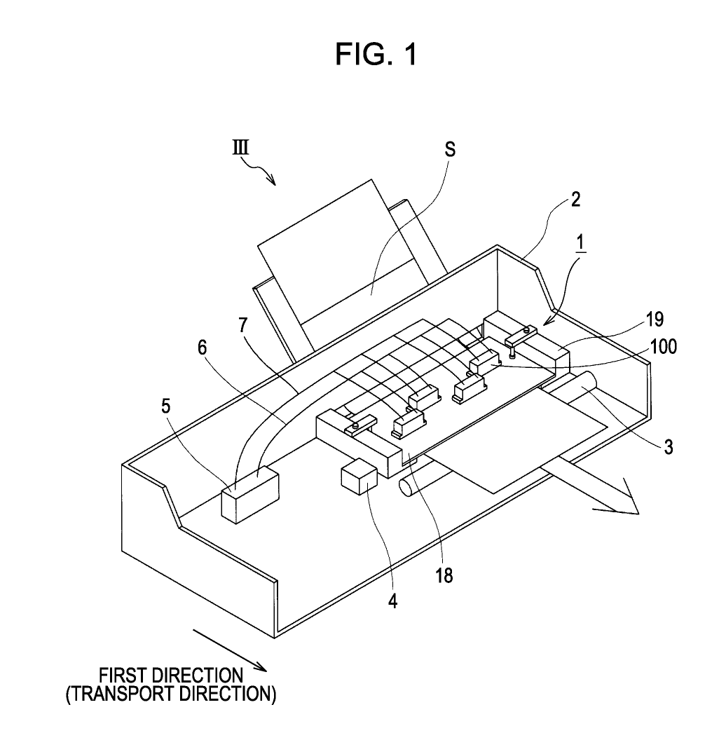

A liquid ejecting apparatus according to an aspect of the present invention will be described with reference to FIGS. 1 to 6A and 6B. The ink jet recording apparatus according to the embodiment of the invention is a so-called line type ink jet recording apparatus which performs printing on a recorded medium in such a way that liquid ejecting heads are fixed in an ink jet recording apparatus body, and a recording medium, such as a recording paper, is transported in a direction orthogonal to the nozzle column direction. An ink jet recording apparatus III shown in FIG. 1 includes a head unit 1, an apparatus body 2, a feeding roller 3, which is an example of a movement unit, and a control unit 4.

The head unit 1 includes a frame member 19 attached to a base plate 18 on which a head group (meanwhile, each head group includes four heads 100 in FIG. 1) including a plurality of liquid ejecting heads (hereinafter, refer to heads) 100 is held, and the head unit 1 is fixed to the apparatus body 2 through the frame member 19.

Furthermore, a feeding roller 3 is provided in the apparatus body 2. The feeding roller 3 transports a recording sheet S (medium to be recorded), such as paper fed to the apparatus body 2, in the first direction, and passes the recording sheet S to the discharge surface sides of the heads 100. Here, the first direction is referred to as the relative movement direction of the recording sheet S and the heads 100. In the present embodiment, since the head unit 1 is fixed to the apparatus body 2, the recording sheet S is transported by the feeding roller 3.

The control unit 4 sends a signal to the feeding roller 3, transports the recording sheet S based on print data which represents an image to be printed on the recording sheet S, and sends a driving signal to each of the heads 100 through wiring (not shown).

Furthermore, an ink storage unit 5 in which ink is stored is provided in the apparatus body 2. Although the detailed description will be described later in the present embodiment, a supply pipe 6 used to supply ink from the ink storage unit 5 to each of the heads 100 and a recovery pipe 7 used to recover ink from each of the heads 100 to the ink storage unit 5 are provided in the ink storage unit 5. That is, in the present embodiment, the supply pipe 6 and the recovery pipe 7 are provided in the ink storage unit 5, ink is supplied from the ink storage unit 5 to the ink flow path (liquid flow path) of each of the heads 100 through the supply pipe 6, ink which has not been ejected from nozzle openings is recovered to the ink storage unit 5 through the recovery pipe 7. A heating unit (not shown) that heats stored ink is provided in the ink storage unit 5. As described above, in the present embodiment, an ink circulation path that includes the supply pipe 6, the recovery pipe 7 and the ink flow path of each of the heads 100 and that circulates heated ink from the ink storage unit 5 is provided.

In the above-described ink jet recording apparatus III, ink is discharged by the heads 100 of the head unit 1 while the recording sheet S is transported in the first direction by the feeding roller 3, so that an image or the like is printed on the recording sheet S.

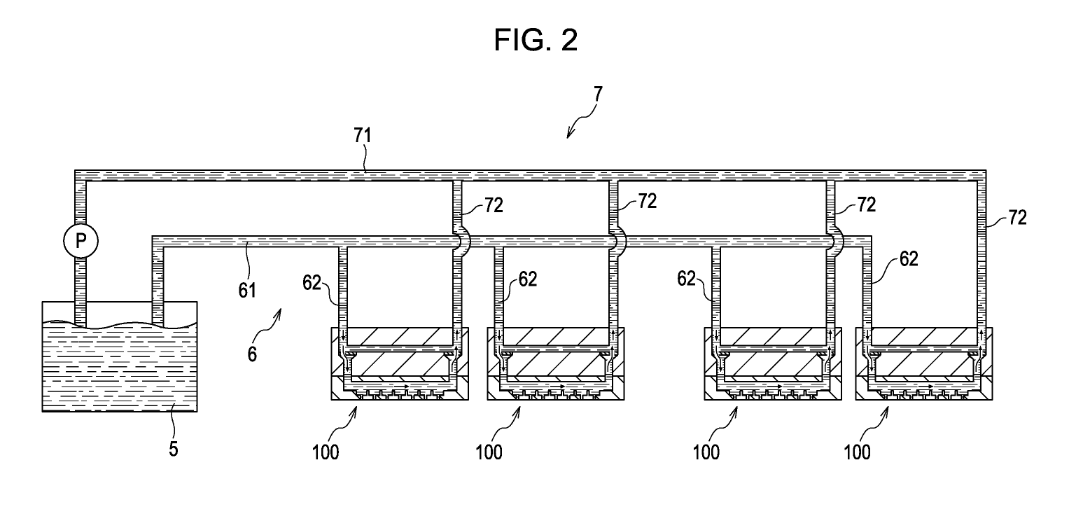

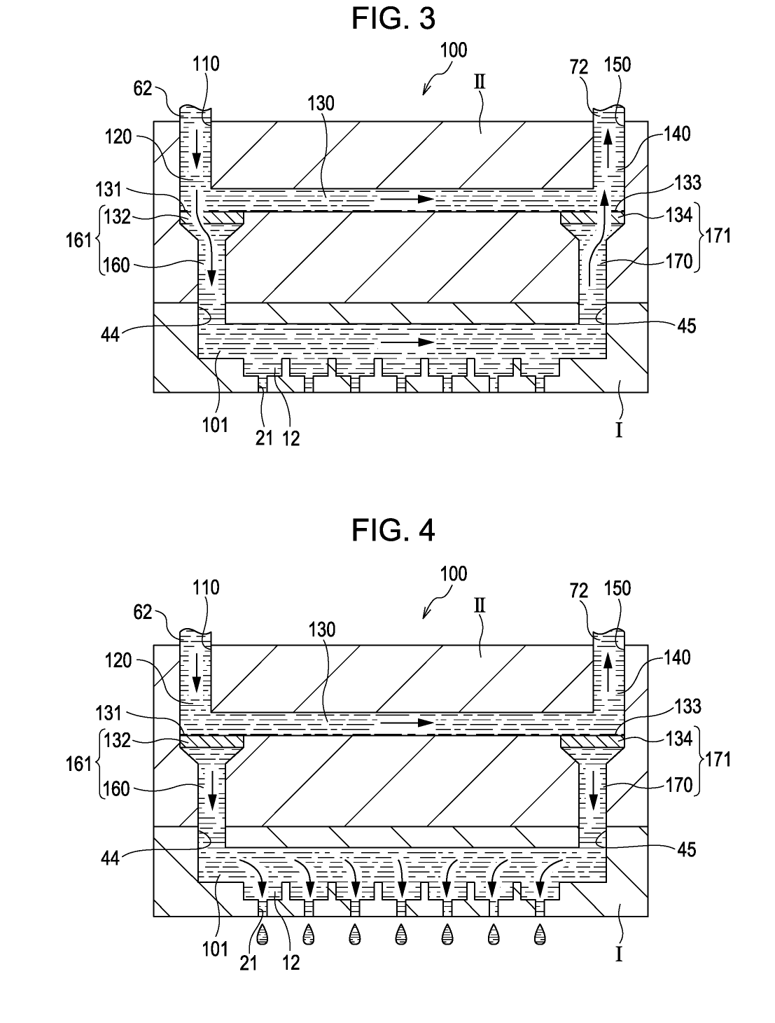

Hereinafter, the ink circulation path will be described in detail with reference to FIGS. 2 and 3. Arrows represent the flow of ink in FIGS. 2 and 3. As described above, the ink circulation path includes the supply pipe 6, the ink flow path formed in each of the heads 100, and the recovery pipe 7.

The supply pipe 6 includes a piece of main supply pipe 61 connected to the ink storage unit 5, and subsidiary supply pipes 62 provided in the main supply pipe 61 and configured to supply ink to the respective heads 100. The recovery pipe 7 includes one primary recovery pipe 71 connected to the ink storage unit 5, and secondary recovery pipes 72 provided in the primary recovery pipe 71 and configured to recover ink from the respective heads 100. A pump P is provided between the primary recovery pipe 71 and the ink storage unit 5. Attributable to the negative pressure generated by the pump P, the ink of each of the heads 100 is recovered to the ink storage unit 5 from the heads 100 through the recovery pipe 7. The drawn ink is supplied to the heads 100 again from the ink storage unit 5 through the supply pipe 6, thereby forming a configuration in which ink is circulated.

As shown in FIG. 3, each of the heads 100 includes a head body I (which will be described in detail later), in which a plurality of nozzle openings 21 and a reservoir 101 which is a first flow path communicated with the nozzle openings 21 are formed, and a flow path member II, in which an ink flow path between the head body I and the subsidiary supply pipe 62 and an ink flow path between the head body I and the secondary recovery pipe 72 are formed. The flow path member II includes an ink inlet 110 which is an opening provided on the upper surface of the flow path member II and to which ink is introduced, an upper supply path 120 communicated with the ink inlet 110, and a connection path (second flow path) 130 in which one end is communicated with the upper supply path 120 at the lower end of the upper supply path 120.

An upper recovery path 140 that discharges ink accumulated in the connection path 130 is provided on the other end of the connection path 130. The upper recovery path 140 is provided on the upper surface of the flow path member II, and is communicated with an ink discharge outlet 150 through which ink in the heads 100 is discharged. The secondary recovery pipe 72 is connected to the ink discharge outlet 150. An upper side circulation path is configured by the upper supply path 120, the connection path 130, and the upper recovery path 140.

A first filter opening 131, which is an opening, is provided on the lower surface side of the connection path 130 such that the first filter opening 131 faces the upper supply path 120, and a first filter 132 is provided in the first filter opening 131. Further, a head side supply path 160 communicated with the first filter opening 131 through the first filter 132, connected to the head body I and configured to supply ink to the head body I is provided on the first filter opening 131. The head side supply path 160 is communicated with the reservoir 101 of the head body I through a first opening 44 provided on a compliance substrate of the head body I, which will be described later. That is, in the present embodiment, the head side supply path 160 connects the connection path 130 and the reservoir 101.

Further, the supply side flow path 161 described in the embodiment of the invention is the flow path of the supply side between the connection path 130 and the reservoir 101. That is, the supply side flow path 161 includes the head side supply path 160 and the first filter 132.

The reservoir 101 constitutes a part of the liquid flow path of the head body I. The reservoir 101 is communicated with pressure generation chambers 12 and the nozzle openings 21 which are provided in the respective pressure generation chambers 12 and configured to discharge ink. That is, the reservoir 101 is a common flow path to which the pressure generation chambers 12, functioning as separate flow paths which are communicated with the respective nozzle openings 21, are connected in common. Furthermore, a second opening 45 is provided on the compliance substrate which seals the reservoir 101, and a head side recovery path 170 communicated with the reservoir 101 through the second opening 45 is provided in the flow path member II. The head side recovery path 170 is communicated with a second filter opening 133, which is an opening provided on the lower surface of the connection path 130, through the second filter 134. That is, the head side recovery path 170 connects the connection path 130 and the reservoir 101.

Furthermore, a recovery side flow path 171 described in the embodiment of the invention is the flow path of a recovery side between the connection path 130 and the reservoir 101. That is, the recovery side flow path 171 includes the head side recovery path 170 and the second filter 134.

The head side recovery path 170 is configured in such a way that the cross-sectional area of a surface which is vertical to the direction through which ink flows (hereinafter, simply refer to as a cross-sectional area) is larger than the cross-sectional area of the head side supply path 160 as described in detail later. A lower side circulation path is constituted by the head side supply path 160, the ink flow path of the head body I, and the head side recovery path 170. Furthermore, the supply path is constituted by the upper supply path 120 and the head side supply path 160, and the recovery path is constituted by the upper recovery path 140 and the head side recovery path 170.

The first filter 132 and the second filter 134 are provided to control discharge defects, such as a dead pixel attributable to bubbles and a nozzle clogging attributable to the dust of ink, and to remove bubbles and dust in ink. A sheet-shaped filter having openings may be used as the first filter 132 and the second filter 134. For example, a sheet-shaped filter in which a plurality of fine openings are formed by minutely twisting a metal or a filter in which fine openings are formed on a metal substrate can be used.

In the present embodiment, the sedimentation of ink components deposited in the flow path of the flow path member II can be controlled and bubbles accumulated in the first filter 132 and the second filter 134 can be recovered using the upper side circulation path. In the present embodiment, the sedimentation of the ink components in the head body I can be controlled using the lower side calculation path. Therefore, in the liquid ejecting apparatus III according to the present embodiment, the clogging of the nozzles is controlled, so that the ejection property of ink is improved.

The ink ejection operation of the liquid ejecting apparatus III according to the present embodiment will be described. First, when ink is circulated, ink supplied from the ink storage unit 5 is introduced to the heads 100 from the ink inlet 110 of the flow path member II of the head 100 through the main supply pipe 61 and the subsidiary supply pipe 62. The introduced ink is supplied to the connection path 130 through the upper supply path 120. Thereafter, ink is filtered by the first filter 132, passes through the head side supply path 160, and introduced to the pressure generation chamber 12 from the reservoir 101 of the head body I.

In this case, in the present embodiment, in order to easily introduce ink to the lower side circulation path, the cross-sectional surface of the connection path 130 is set to be slightly small such that flow path resistance increases than that of related art. With the configuration as described above, ink is sufficiently supplied so as to easily flow to the lower side circulation path at the time of ink ejection, with the result that a sufficient amount of ink can be supplied to the head body I, so that the sedimentation of the ink components can be controlled. Meanwhile, if the flow path resistance of the connection path 130 becomes considerably higher than that of the related art, for example, if a configuration is made in such a way that the flow path resistance of the connection path 130 is higher than that of the downstream side circulation path, the amount of ink to be supplied to the head side recovery path 170 decreases, so that the advantage of the present embodiment which will be described later cannot be achieved.

Thereafter, ink in the reservoir 101 is recovered from the reservoir 101 through the head side recovery path 170 and the upper recovery path 140 by the pump P, and ink in the connection path 130 is recovered from the connection path 130 through the upper recovery path 140. At the same time, new ink is introduced to the heads 100 through the supply pipe 6. Therefore, ink is circulated in the heads 100.

When ink is circulated in the heads 100 and ink is ejected from the nozzle openings 21, the flow of ink is changed as shown in FIG. 4. That is, at the time of ink ejection, ink is introduced to the pressure generation chamber 12 even from the head side recovery path 170. With respect to another flow path, the flow of ink is not changed.

However, based on the configuration made in such a way that the flow path resistance of the connection path 130 is a little higher than that of the related art as described above, the amount of ink may decrease in the downstream side (the upper recovery path 140 side) of the connection path 130. In this case, if a configuration is made in such a way that the flow path resistance of the supply side flow path is the same as that of the recovery side flow path, it can be considered that the amount of ink to be introduced to the head side recovery path from the connection path through the second filter decreases at the time of ejection. Therefore, in this case, the amount of ink ejected from the nozzle openings of the head side recovery path decreases, compared with the nozzle openings of the head side supply path at the time of the ejection of ink. That is, if the flow path resistance of the connection path is a little high in order to control the sedimentation of the ink component, there is a problem in that the amount of ink to be ejected is not uniform in the arrangement direction of the nozzle openings.

Here, in the present embodiment, the cross-sectional area of the head side recovery path 170 is larger than that of the head side supply path 160, that is, the head side recovery path 170 is larger than the head side supply path 160, such that the flow path resistance of the recovery side flow path 171 is lower than that of the supply side flow path 161. Therefore, since ink can easily flow from the connection path 130 to the recovery side flow path 171 at the time of ejection, a sufficient amount of ink can be introduced to the nozzle openings 21 of the recovery side flow path 171 side, so that an appropriate amount of ink can be ejected from the nozzle openings 21. Therefore, the amount of ink to be ejected is substantially uniform in the arrangement direction of the nozzle openings 21. In particular, a configuration is made in such a way that the flow path resistance of the supply side flow path 161, the flow path resistance of the connection path 130, and the flow path resistance of the recovery side flow path 171 are substantially the same, with the result that the amount of ink which passes through the supply side flow path 161 and the amount of ink which passes through the recovery side flow path 171 are substantially uniform, so that the amount of ink to be ejected is more uniformalized in the arrangement direction of the nozzle openings 21.

That is, in the present embodiment, the flow path resistance of the connection path 130 is slightly high such that the sedimentation of liquid component is controlled and a large amount of ink can be circulated to the downstream side circulation path. However, since the liquid ejection property is not uniform in this case, the flow path resistance of the recovery side flow path 171 is additionally lowered such that the liquid ejection property is substantially uniform.

In order to lower the flow path resistance of the recovery side flow path 171 as described above, the invention is not limited to the configuration made in such a way that the cross-sectional area of the head side recovery path 170 is larger than the cross-sectional area of the head side supply path 160 as described in the present embodiment. For example, the total area of the openings of the second filter 134 may be wider than the total area of the openings of the first filter 132. When the opening ratio of the second filter 134 is higher than the opening ratio of the first filter 132 in this manner, the flow path resistance of the recovery side flow path 171 is lower than the flow path resistance of the supply side flow path 161, with the result that ink is sufficiently ejected from the nozzle openings 21 of the head side recovery path 170 side at the time of ink ejection, so that the ink ejection property becomes uniform. Further, a plurality of first filters 132 may be provided in the supply side flow path 161.

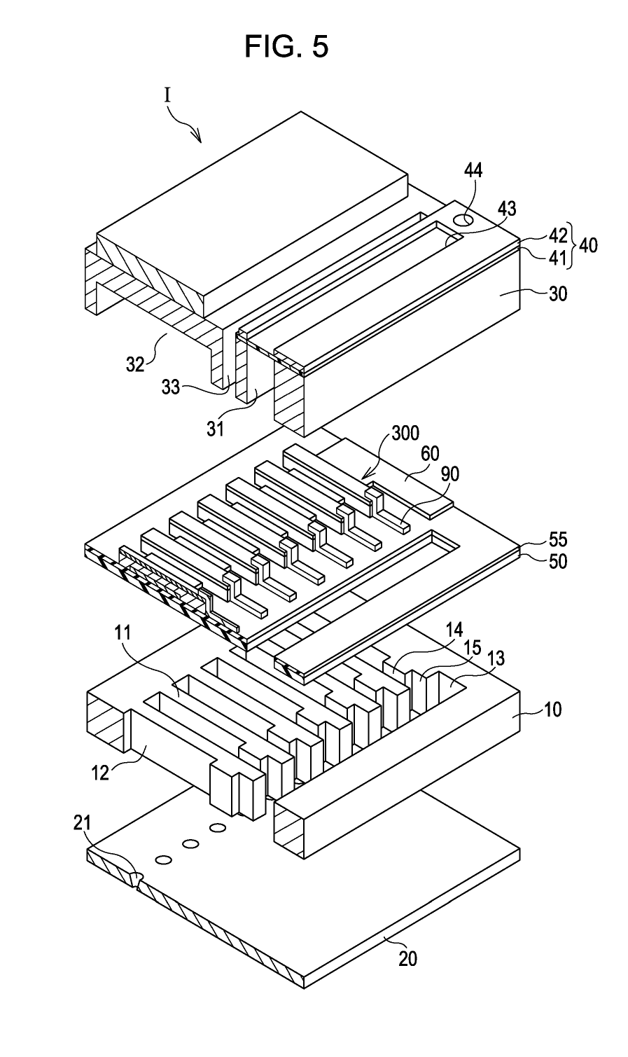

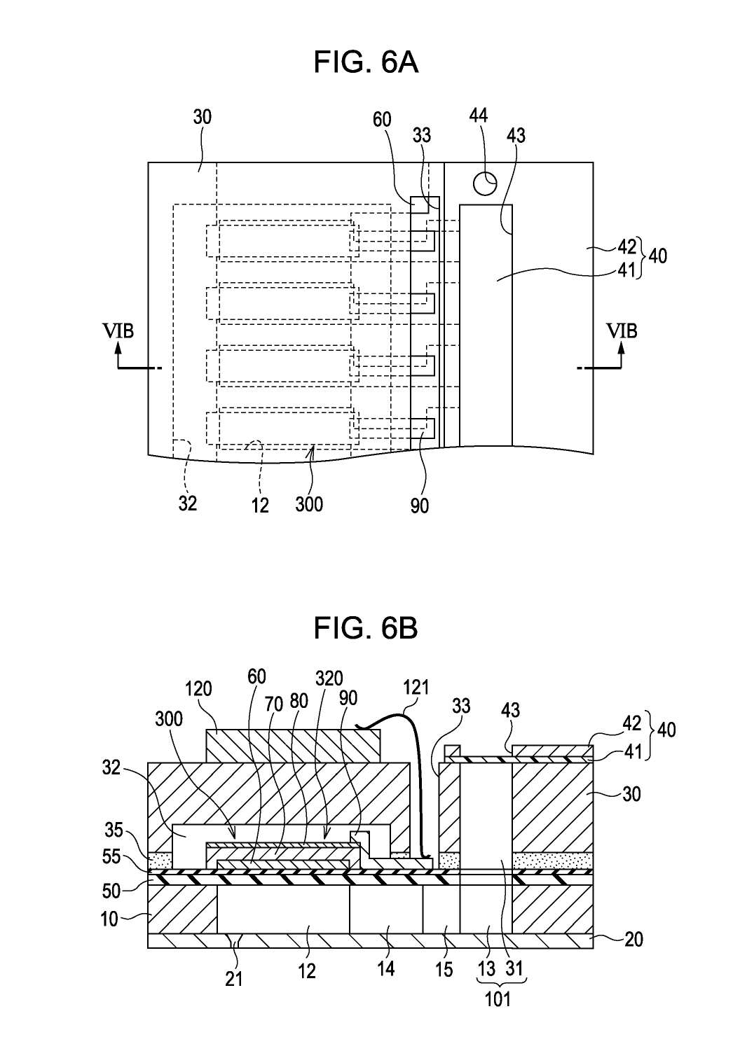

Hereinafter, the liquid ejecting head body will be described with reference to FIGS. 5, 6A, and 6B. FIG. 5 is an exploded schematic diagram illustrating the schematic configuration of the ink jet recording head body which is an example of the liquid ejecting head, and FIG. 6A is a plan view of the ink jet recording head body and FIG. 6B is a cross-sectional view taken along VIB-VIB.

As shown in the drawings, a flow path formation substrate 10 includes a silicon single-crystal substrate, and an elastic film 50 made of, for example, silicon dioxide, is formed on one surface of the flow path formation substrate 10. An anisotropic etching is performed on the other surface of the flow path formation substrate 10, so that a plurality of pressure generation chambers 12 partitioned by a plurality of walls 11 are arranged in the width direction (transverse direction) thereof in the flow path formation substrate 10. Further, an ink supply path 14 and a communication path 15 are partitioned by a wall 11 at one end side of the pressure generation chamber 12 of the flow path formation substrate 10 in the lengthwise direction. Further, a communication section 13, which constitutes a part of the reservoir 101 which is the common ink chamber (liquid chamber) of each pressure generation chamber 12, is formed in one end of the communication path 15. That is, a liquid flow path, including the pressure generation chamber 12, the communication section 13, the ink supply path 14 and the communication path 15, is provided in the flow path formation substrate 10.

The ink supply path 14 is communicated in one end of the pressure generation chamber 12 in the lengthwise direction of the pressure generation chamber 12 and configured to have a cross-sectional area which is smaller than that of the pressure generation chamber 12. Further, each communication path 15 is communicated with the opposite side of the pressure generation chamber 12 of the ink supply path 14, and configured to have a cross-sectional area which is larger than the width direction (transverse direction) of the ink supply path 14. In the present embodiment, the communication path 15 and the pressure generation chamber 12 are formed to have the same cross-sectional area. That is, the pressure generation chamber 12, the ink supply path 14 configured to have a cross-sectional area which is smaller than that of the pressure generation chamber 12 in the transverse direction, and a communication path 15 communicated with the ink supply path 14 and configured to have the cross-sectional area which is larger than that of the ink supply path 14 in the transverse direction and which is the same as that of the pressure generation chamber 12 are partitioned by a plurality of walls 11 and provided in the flow path formation substrate 10.

Further, a nozzle plate 20, in which the nozzle openings 21 are formed, is fixed to the opening surface side of the flow path formation substrate 10 using an adhesive layer such as an adhesive or a heat welding film, the nozzle openings communicate with the vicinity of the end which is the opposite side to the ink supply path 14 of each pressure generation chamber 12. Meanwhile, the nozzle plate 20 is formed of a glass ceramics, a silicon single-crystal substrate, or a stainless steel.

On the other hand, the elastic film 50 is formed on another surface of the flow path formation substrate 10, that is, the opposite side of the opening surface of the flow path formation substrate 10, as described above, and an insulation film 55 formed of, for example, oxidized zirconium (ZrO₂), is laminated on the elastic film 50. Furthermore, a piezoelectric element 300, including a first electrode 60, a piezoelectric layer 70 and a second electrode 80, is formed on the insulation film 55. Here, the piezoelectric element 300 indicates a section which includes the first electrode 60, the piezoelectric layer 70, and the second electrode 80. Generally, the piezoelectric element 300 is configured in such a way that the electrode of any one side of the piezoelectric element 300 functions as a common electrode, and an electrode on the other side and the piezoelectric layer 70 are patterned for each pressure generation chamber 12. Further, a section which includes the pattern electrode of any one side and the piezoelectric layer 70 and in which piezoelectric strain is generated by applying voltage to the both electrodes is referred to as a piezoelectric active portion. Although the first electrode 60 functions as the common electrode of the piezoelectric element 300 and the second electrode 80 functions as the separate electrode of the piezoelectric element 300 in the present embodiment, there is no problem even if they are reversed according to a driving circuit or a wiring. In any case, the piezoelectric active portion is formed for each pressure generation chamber 12. Further, here, the piezoelectric element 300 and a vibration plate in which phase is generated by driving the corresponding piezoelectric element 300 are referred to as an actuator apparatus. Meanwhile, the first electrode 60 is provided in the arrangement direction of the plurality of piezoelectric elements 300 in the present embodiment, one end of the first electrode 60 in the lengthwise direction of the pressure generation chamber 12 is provided in a location which faces the pressure generation chamber 12. Furthermore, although the elastic film 50, the insulation film 55, and the first electrode 60 function as the vibration plate in the above-described example, the present invention is not limited thereto. For example, only the first electrode 60 may function as the vibration plate without providing the elastic film 50 and the insulation film 55.

Thereafter, a lead electrode 90 formed of, for example, gold (Au), is connected to the second electrode 80 of the piezoelectric element 300, and voltage is selectively applied to the piezoelectric element 300 through the lead electrode 90.

Further, a reservoir section 31 is provided in the area of the protection substrate 30, which faces the communication section 13. The reservoir section 31 is communicated with the communication section 13 of the flow path formation substrate 10, and is included in the reservoir 101 which is the common ink chamber of each pressure generation chamber 12 as described above. Furthermore, a through-hole 33 which penetrates the protection substrate 30 in the thickness direction is provided in an area between the piezoelectric element holding section 32 of the protection substrate 30 and the reservoir section 31, and a part of the first electrode 60 and the tip section of the lead electrode 90 are exposed in the through-hole 33, and a driving circuit for driving the piezoelectric element 300 is electrically connected to the tip section through a conductive wiring (not shown).

It is preferable that a material in which the rate of thermal expansion is substantially the same as that of the flow path formation substrate 10, for example, glass or ceramics, be used for the protection substrate 30. In the present embodiment, a material which is the same as that of the flow path formation substrate 10, that is, the silicon single-crystal substrate with a face having a crystal face orientation of 110, is used.

A compliance substrate 40 including a sealing film 41 and a fixed plate 42 is bonded on the protection substrate 30. Here, the sealing film 41 is formed of a flexible material which has low stiffness (for example, a PolyPhenylene Sulfide (PPS) film), and one surface of the reservoir section 31 is sealed by the sealing film 41. Further, the fixed plate 42 is formed of a hard material such as a metal (for example, a stainless steel (SUS)). Since the area of the fixed plate 42, which faces the reservoir 101, corresponds to an opening section 43 which is completely removed in the thickness direction, one surface of the reservoir 101 is sealed only by the sealing film 41.

The first opening 44 and the second opening 45 (refer to FIG. 3) are provided on the compliance substrate 40, and the head side supply path 160 (refer to FIG. 3) is communicated with the first opening 44 and the head side recovery path 170 (refer to FIG. 3) is communicated with the second opening 45 as described above. Therefore, a configuration is made in such a way that ink is supplied from the ink storage unit 5 (refer to FIG. 2) to the reservoir 101, and ink is discharged from the ink storage unit 5 at the time of a bubble discharge operation as described above.

In the head body I according to the embodiment, ink is fetched from an external ink supply unit (not shown), the inside ranging from the reservoir 101 to the nozzle openings 21 is filled with ink using the above-described filling operation, voltage is applied between the first electrode 60 and the second electrode 80 which correspond to each of the pressure generation chambers 12 in response to a recording signal from a driving circuit (not shown), and deflection deformation is performed on the elastic film 50, the insulation film 55, the first electrode 60, and the piezoelectric layer 70, so that the pressure inside of each of the pressure generation chambers 12 increases and ink drops are discharged from the nozzle openings 21.

### Another Embodiment

Furthermore, the embodiment according to the present invention is not limited to the above-described embodiment. For example, although a line type ink jet recording apparatus in which each head is fixed has been described in the above-described embodiment, a so-called serial type ink jet recording apparatus can be used. Meanwhile, the serial type ink jet recording apparatus performs printing while moving liquid ejecting heads in the direction which crosses the transport direction of a medium to be recorded. Further, although the ink jet recording apparatus using four heads has been described in the above-described embodiment, the number of the heads is not limited thereto, and, for example, an ink jet recording apparatus using a single head may be used.

In the present embodiment, although the first filter 132 and the second filter 134 are provided on the lower surface (under surface) of the connection path 130, the invention is not limited thereto. The first filter 132 may be provided in the head side supply path 160, and the second filter 134 may be provided in the head side recovery path 170.

In the present embodiment, although the supply pipe 6 that supplies ink from the ink storage unit 5 to the heads 100 and the recovery pipe 7 that recovers ink from the heads 100 to the ink storage unit 5 have been described, the invention is not limited thereto. For example, a flow path, formed by removing a part of a silicon substrate by performing etching, may be used.

Furthermore, although the embodiment of the invention has been described by illustrating the ink jet recording head 100 that discharges ink drops as an example in the above-described embodiment, the present invention is extensively designed for overall liquid ejecting heads. For example, recording heads used for an image recording apparatus of a printer or the like, color material ejecting heads used to manufacture the color filter of a liquid crystal display or the like, electrode material-ejecting heads used to form electrodes of an organic Electro-Luminescent (EL) display or a Field Emission Display, and bio-organic material ejecting heads used to manufacture a biochip may be used as the liquid ejecting heads.

What is claimed is:

1. A liquid ejecting head comprising:
a plurality of nozzle openings that eject a liquid;
a first flow path that is communicated with the plurality of nozzle openings and in which the liquid is circulated;
a supply path that supplies the liquid to the first flow path from an outside;
a recovery path that recovers the liquid from the first flow path to the outside;
a first filter that is provided in the supply path;
a second filter that is provided in the recovery path; and
a second flow path that connects the supply path provided in an upstream side of the first filter and the recovery path provided in downstream side of the second filter,
wherein a recovery side flow path between the first flow path and the second flow path of the recovery path has a flow path resistance which is lower than flow path resistance of the supply side flow path between the first flow path and the second flow path of the supply path.

2. The liquid ejecting head according to claim 1,
wherein a cross-sectional area of the recovery side flow path is larger than a cross-sectional area of the supply side flow path.

3. The liquid ejecting head according to claim 1,
wherein a total area of an opening of the second filter provided in the recovery path is wider than a total area of an opening of the first filter provided in the supply path.

4. The liquid ejecting head according to claim 1,
wherein the supply side flow path has a flow path resistance which is the same as the flow path resistance of a flow path including the recovery side flow path and the second flow path.

5. A liquid ejecting head unit comprising a plurality of liquid ejecting heads according to claim 1.

6. A liquid ejecting head unit comprising a plurality of liquid ejecting heads according to claim 2.

7. A liquid ejecting head unit comprising a plurality of liquid ejecting heads according to claim 3.

8. A liquid ejecting head unit comprising a plurality of liquid ejecting heads according to claim 4.

9. A liquid ejecting apparatus comprising the liquid ejecting head according to claim 1.

10. A liquid ejecting apparatus comprising the liquid ejecting head according to claim 2.

11. A liquid ejecting apparatus comprising the liquid ejecting head according to claim 3.

12. A liquid ejecting apparatus comprising the liquid ejecting head according to claim 4.

13. A liquid ejecting apparatus comprising a plurality of liquid ejecting heads according to claim 1.

14. A liquid ejecting apparatus comprising a plurality of liquid ejecting heads according to claim 2.

15. A liquid ejecting apparatus comprising a plurality of liquid ejecting heads according to claim 3.

16. A liquid ejecting apparatus comprising a plurality of liquid ejecting heads according to claim 4.
